(19) United States
(12) Patent Application Publication
(10) Pub. No.: US 2015/0356982 A1
(43) Pub. Date: Dec. 10, 2015

(54) SPEECH DETECTION CIRCUIT AND METHOD

(71) Applicant: Brian CHESNEY, Pittsburgh, PA (US)

(72) Inventor: Brian Chesney, Pittsburgh, PA (US)

(73) Assignee: Robert Bosch GmbH, Stuttgart (DE)

(21) Appl. No.: 14/655,396

(22) PCT Filed: Sep. 25, 2014
(86) PCT No.: PCT/US2014/057408

§ 371 Date: Jun. 25, 2015

Related U.S. Application Data
(60) Provisional application No. 61/882,122, filed on Sep. 25, 2013.

(51) Int. Cl. G10L 25/78; G10L 17/22

(52) U.S. Cl. CPC G10L 25/78; G10L 17/22

(57) ABSTRACT

A speech detection circuit (SDC). The SDC includes a first-in, first-out (FIFO) memory array, a multiplier, a summer, a fast Fourier transformer, a counter, an RMS comparator, and a sparsity comparator. The FIFO stores a plurality of data samples. The multiplier squares the data samples. The summer sums the plurality of squared data samples. The fast Fourier transformer performs an FFT on the plurality of data samples. The counter counts a quantity of the plurality of data samples that exceed a spectral threshold. The RMS comparator compares the summed plurality of squared data samples to an RMS threshold, the quantity of which are compared to a sparsity threshold. The SDC then outputs a wakeup signal when the summed plurality of squared data samples exceeds the RMS threshold and the quantity of the plurality of data samples that exceed the spectral threshold is less than the sparsity threshold.

### RELATED APPLICATION

The present patent application claims the benefit of prior filed co-pending U.S. Provisional Patent Application No. 61/882,122, filed on Sep. 25, 2013, the entire content of which is hereby incorporated by reference.

### BACKGROUND

The present invention relates to detecting human speech to wake up a device (e.g., a laptop, tablet or smart phone).

The invention contrasts sharply with other methods that seek to detect voice/non-voice, no matter what the cost, such as methods using probability distributions, voice encoders, learning methods, etc. These methods are not concerned with waking up a system and conserving energy. Instead they are primarily concerned with classifying voice, regardless of cost (in terms of energy), and are very processor-intensive.

Other methods, such as the method proposed in (Tobi Delbruk, 2010), only output “possible” vocal events and require the host system to wake-up and decide if the event actually constitutes speech or not. This is not power efficient and is not actually a “fully-integrated” voice detection approach.

### SUMMARY

The ability to recognize a human voice can be useful for deciding to wakeup a system such as a laptop computer, tablet computer or cellular phone. The device can remain in an ultra-low power state while only the microphone remains on to detect a user's voice. This provides a significant power savings to the overall system, but adds complexity to the microphone and/or codec.

A speech detection circuit (SDC) allows devices (e.g., laptops, tablets and smart phones) to stay in a low power mode, until the user activates the higher power mode with speech, extending battery life. The SDC is robust and reduces false triggering caused by high volume noise.

In one embodiment, the invention provides a speech detection circuit (SDC). The SDC includes a first-in, first-out (FIFO) memory array, a multiplier, a simmer, a fast Fourier transformer, a counter, an RMS comparator, and a sparsity comparator. The FIFO stores a plurality of data samples. The multiplier squares the data samples. The summer sums the plurality of squared data samples. The fast Fourier transformer performs an FFT on the plurality of data samples. The counter counts a quantity of the plurality of data samples that exceed a spectral threshold. The RMS comparator compares the summed plurality of squared data samples to an RMS threshold, the quantity of which are compared to a sparsity threshold. The SDC then outputs a wakeup signal when the summed plurality of squared data samples exceeds the RMS threshold and the quantity of the plurality of data samples that exceed the spectral threshold is less than the sparsity threshold.

In another embodiment, the invention provides an electronic device. The electronic device includes a power source, a microphone, and a speech detection circuit (SDC). The SDC is configured to receive a plurality of data samples from the microphone, and to square the plurality of data samples, sum the plurality of squared data samples, compare the sum with an RMS threshold multiplied by the number of data samples in the plurality of data samples, perform a fast Fourier transform on the plurality of data samples, determine a quantity of data samples of the plurality of data samples which are above a spectral threshold, compare the quantity of data samples of the plurality of data samples which are above the spectral threshold with a sparsity threshold, and wake up the electronic device when the sum exceeds the RMS threshold multiplied by the number of data samples in the plurality of data samples and the quantity of data samples of the plurality of data samples which are above the spectral threshold is below the sparsity threshold.

In another embodiment, the invention provides a method of waking up an electronic device. The method includes the steps of receiving a plurality of data samples, squaring the plurality of data samples, summing the plurality of squared data samples, comparing the sum with an RMS threshold multiplied by the number of data samples in the plurality of data samples, performing a fast Fourier transform on the plurality of data samples, determining a quantity of data samples of the plurality of data samples which are above a spectral threshold, comparing the quantity of data samples of the plurality of data samples which are above the spectral threshold with a sparsity threshold, and waking up the electronic device when the sum exceeds the RMS threshold multiplied by the number of data samples in the plurality of data samples and the quantity of data samples of the plurality of data samples which are above the spectral threshold is below the sparsity threshold.

Other aspects of the invention will become apparent by consideration of the detailed description and accompanying drawings.

### BRIEF DESCRIPTION OF THE DRAWINGS

FIG. 1 is a time domain plot from a microphone.

FIG. 2 is a graph showing high RMS outputs of the time domain plot of FIG. 1.

FIG. 3 is a graph of the frequency spectrum of a window of voice output of a microphone.

FIG. 4 is a graph of the frequency spectrum of a window of noise output of a microphone.

FIG. 5 is a block diagram of an embodiment of an SDC.

FIG. 6 is a block diagram of an alternative embodiment of an SDC.

FIG. 7 is a flow chart of the operation of the SDC.

FIG. 8 is a block diagram of an electronic device incorporating the invention.

### DETAILED DESCRIPTION

Before any embodiments of the SDC are explained in detail, it is to be understood that the SDC is not limited in its application to the details of construction and the arrangement of components set forth in the following description or illustrated in the following drawings. The SDC is capable of other embodiments and of being practiced or of being carried out in various ways.

The SDC is a fully-integrated approach, which is power efficient, detects speech autonomously, and does not push the decision to the host processor. The SDC does not require interaction with software or a host CPU to recognize speech, allowing the SDC to be implemented in a low-power microphone. Thus, the host CPU can sleep longer increasing the power savings of the entire system.

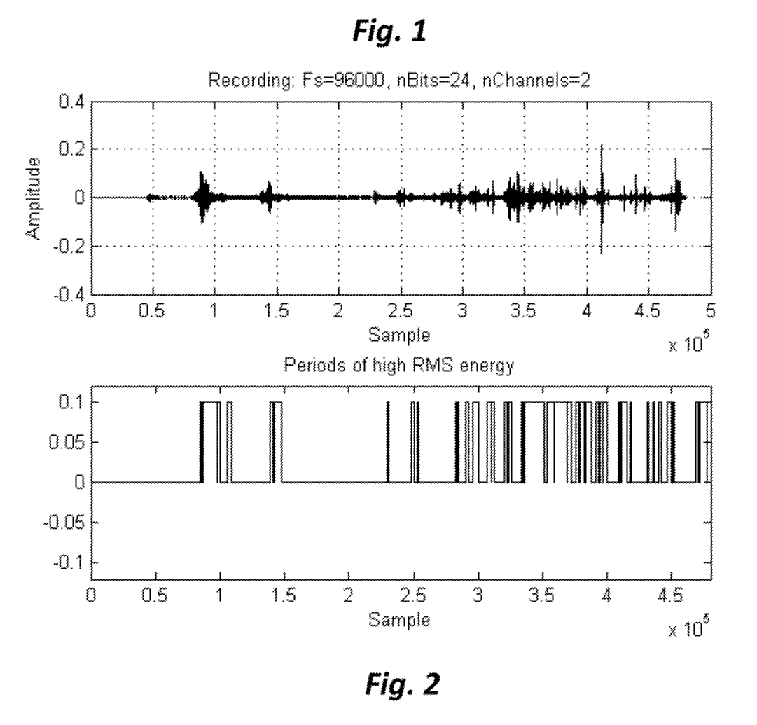

FIG. 1 shows a time domain plot from a microphone. The first recordings, around 1 second and 2 seconds are of human voice. The third recording, around 3-4 seconds is of paper rustling. The voice detection method must correctly identify the voice as reason to wake-up the system, and reject the paper rustling as reason to wake-up the system. The ability to reject false positives directly attests to the robustness and utility of the method as incorrectly waking up on false voice events wastes power. FIG. 2 indicates times when the signal shown in FIG. 1 have high RMS outputs.

The SDC uses a rolling RMS window of the acoustic signal to detect possible speech events. When the RMS power over the window exceeds a threshold, the rest of the voice detection circuit, which is integrated with the microphone, wakes up to decide if it resembles a human voice or not. The first step, in the voice detection, is to take a fast Fourier transform (FFT) over the window of microphone output that exceeds the RMS threshold. The FFT length is the next power of 2 higher than the window length, if it is not an integer power of two.

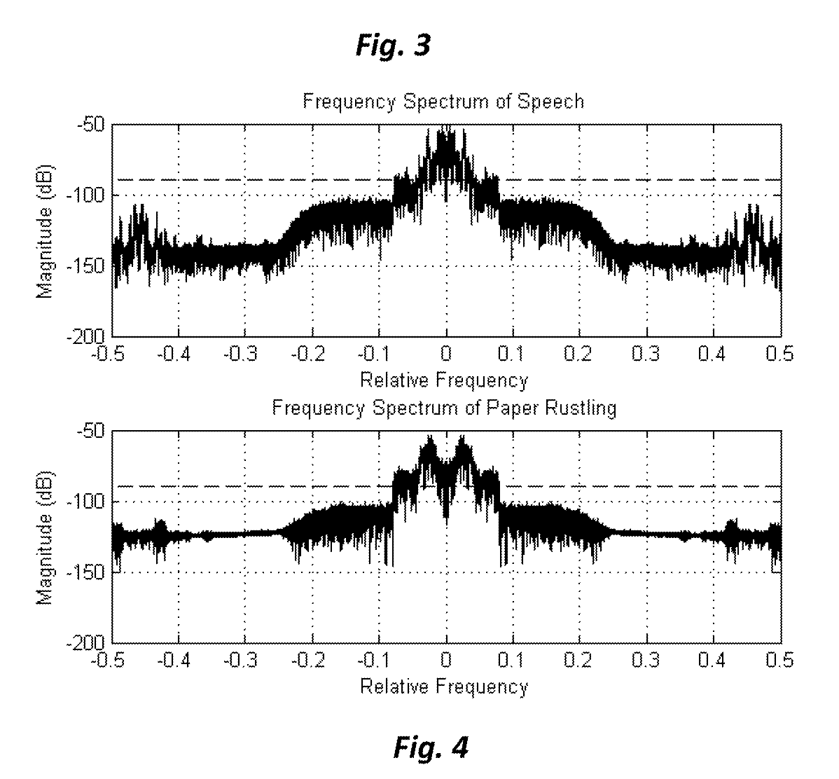

FIG. 3 shows the frequency spectrum of a window of voice output and FIG. 4 show the frequency spectrum of a window of paper rustling. As can be seen in FIGS. 3 and 4, the shapes of the spectra of voice (FIG. 3) and rustling paper (FIG. 4) are very different.

When a window of the acoustic signal is found to exceed the threshold, an FFT is performed on that portion of the signal. Speech and non-speech sounds are distinguished in the frequency domain by their sparsity. Human vocal sounds are very sparse in the frequency domain, regardless of the individual vocal characteristics of the speaker. Many non-speech sounds, such as paper rustling, is broadband noise in the 8 kHz frequency range, the same bandwidth as human vocal sounds, but is not sparse.

The SDC counts the frequency groups above a certain threshold to make a voice/non-voice determination. This lends itself well to circuit implementation in a low-power sensor, such as a microphone. The energy savings to the whole system is significant because the detection method and its implementation are very energy-efficient (e.g., requiring microvolts in sleep mode and millivolts in operating mode). In addition, this method is autonomous, and does not require the host CPU to wake-up to determine if a signal is speech or not.

An embodiment of the method considers frequency content in the 8 kHz band below −95 dB to be zero. The method then counts the number of zeros in the frequency content and compares it to a threshold to determine if the sample is voice or not. For the audio sample plotted in FIG. 2, the voice sample is 69% sparse, meaning that 69% of the spectral content below 8 kHz is below −95 dB. The paper rustling sample is only about 4% sparse. The large spread between 69% and 4% indicates that there are a large number of possible thresholds that do not trigger false positives.

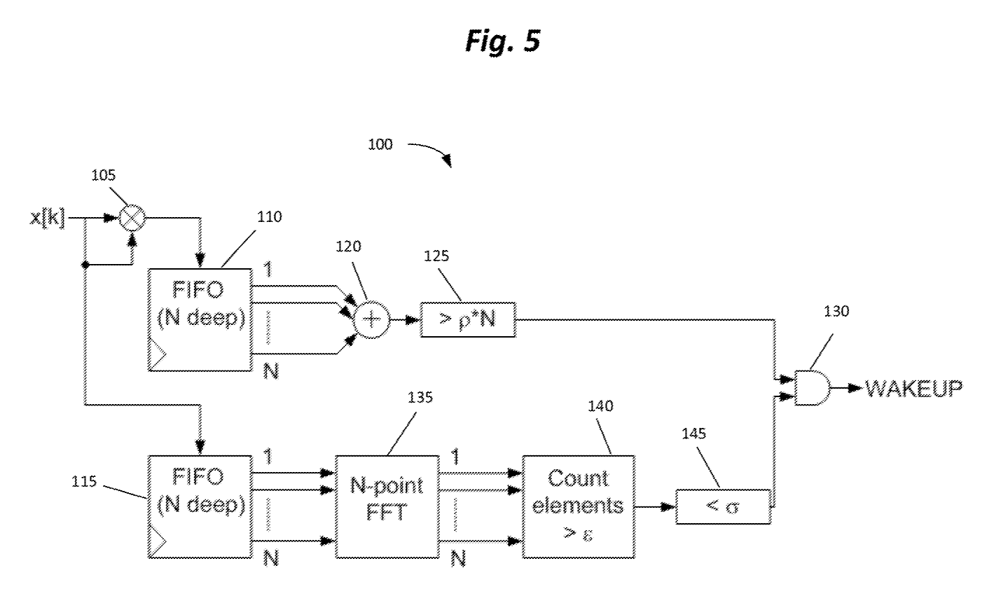

FIG. 5 shows an embodiment of an SDC 100. Data samples (x[k]) are provided to a multiplier 105 which squares the data samples (x[k]) which are clocked into a first FIFO (first in, first out) memory array 110. The data samples (x[k])² in the FIFO 110 are added 120 together and compared 125 to an RMS threshold ρ multiplied by the number of data samples (x[k]). The comparator 125 outputs a logic 1 if the sum of the squared data samples (x[k])² is greater than the RMS threshold ρ multiplied by the number of data samples (x[k]), and a logic 0 if they the sum is less than the RMS threshold ρ multiplied by the number of data samples (x[k]). The output of the comparator 125 is fed to an AND gate 130.

The data samples (x[k]) are also clocked into a second FIFO memory array 115. A fast Fourier transformer 135 performs an FFT on the data samples (x[k]) stored in the second FIFO 115. A counter 140 counts the number of frequency contents of the data samples (x[k]) that are above a spectral threshold (e.g., −95 dB). A comparator 145 compares the number above the threshold to a sparsity threshold φ, and outputs a logic 1 if the number above the threshold is less than the sparsity threshold φ (e.g., 50%). The output of the comparator 145 is a second input to the AND gate 130. If the squared data samples (x[k])² exceed the RMS threshold ρ and the frequency contents of the data samples (x[k]) that are above the spectral threshold is less than the sparsity threshold φ, the AND gate 130 wakes up the system.

The FIFOs can be implemented with SRAM, flip-flops, latches or any other digital storage element.

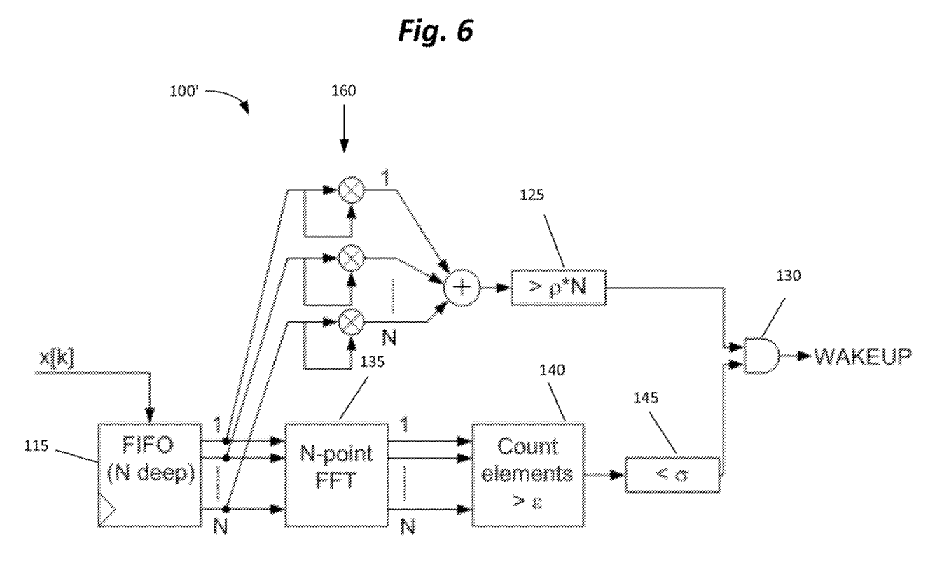

FIG. 6 shows an alternative embodiment of an SDC 100′. The SDC 100′ is the same as SDC 100 of FIG. 5 except there is only one FIFO 115. Each data sample (x[k]) in the FIFO 115 is supplied to a multiplier 160 which squares the data samples (x[k]). The output of the multipliers 160 are provided to the adder 120.

In this description, x is a vector of consecutive acoustic samples, F is the Fourier transform, Fx is the Fourier transform of x. Every time there is a new sample of acoustic data, the oldest sample is shifted out of x and the new sample is included in x. The following thresholds are parameterized in the method. The threshold on the RMS calculation is ρ. The threshold on the spectral content of x, ε, is the value below which any spectral content is considered to be 0. The sparsity threshold, φ, is the threshold below which the number of nonzero elements in the spectrum of x indicates that the received signal is speech and the system should wake-up.

The ∥v∥² notation is equal to the sum of the squares of each element of vector v. The ∥v∥₀ notation is equal to the number of nonzero elements of vector v.

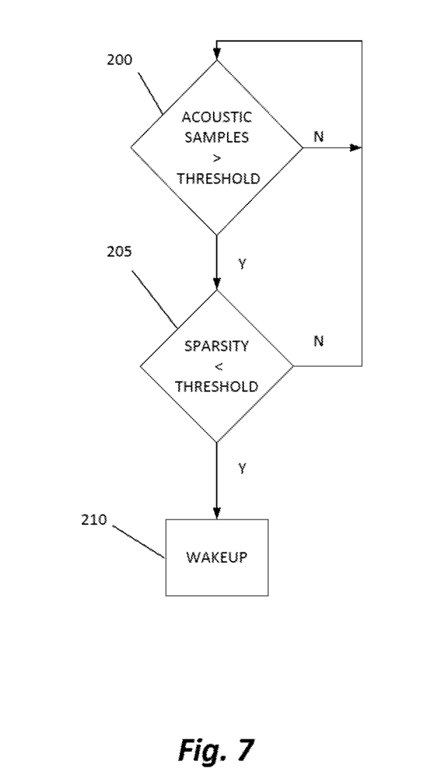

FIG. 7 is a flow chart showing the operation of the SDC 100. The sum ∥x∥² of the data samples (x[k]) squared are compared to the RMS threshold ρ multiplied by the number N of data samples (x[k]) (step 200). If the sum ∥x∥² is greater than the RMS threshold ρ multiplied by the number N, the number ∥Fx−ε∥₀ of the FFT data samples (x[k]) that are greater than the spectral threshold ε are compared to the sparsity threshold φ (step 205). If the number ∥Fx−ε∥₀ is less than the sparsity threshold φ, the system is woken up (step 210).

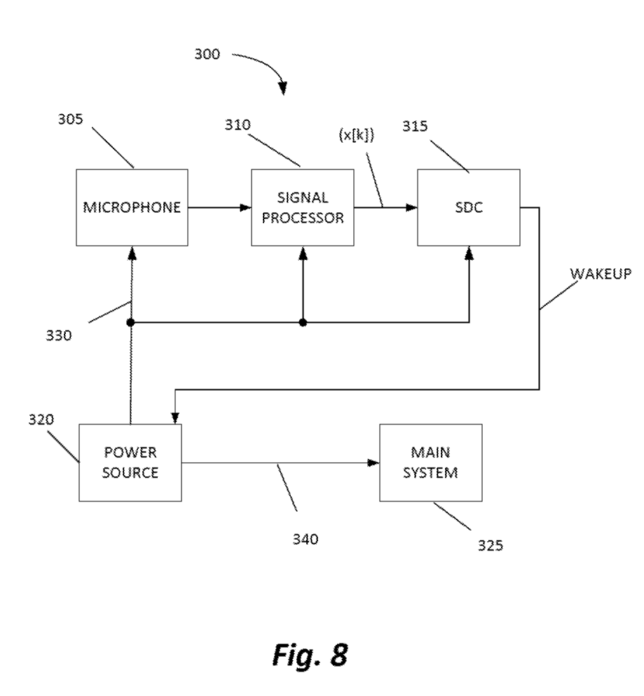

FIG. 8 is a block diagram of an electronic device 300 incorporating the invention. The device 300 includes a microphone 305 (or other sound detection device), a signal processor 310, an SDC 315, a power source 320, and a main system 325. When the device is in sleep mode (i.e., power save mode), little or no power is supplied to the main system via line 340. Low power (e.g., microvolts) is supplied to the microphone 305, the signal processor 310, and the SDC 315. These devices can operate on extremely low voltage. Thus, in sleep mode, the device 300 consumes very little power from the power source 320 extending the amount of time the power source is able to power the device 300. The microphone 305 detects sounds and provides a signal indicative of the sounds to the signal processor 310. The signal processor 310 processes the sounds and outputs the data samples (x[k]) discussed above. The SDC 315 determines, as described above, whether the sounds are voice, and if they are voice, outputs the WAKEUP signal. The power source 320 detects the WAKEUP signal and provides power 340 to the main system 325.

In some embodiments, the microphone 305 and/or the signal processor 310 can be part of the main system 325 and serve one or more purposes for the main system 325 (e.g., a cell phone microphone). Once the main system 325 is powered up, the microphone 305 and signal processor 310 may receive full power from the power source 320.

Thus the invention provides a low power SDC for detecting speech and waking up a device.

1. An electronic device, the electronic device including:
a power source;
a microphone; and
a speech detection circuit (SDC) configured to receive a plurality of data samples from the microphone, and to
square the plurality of data samples,
sum the plurality of squared data samples,
compare the sum with an RMS threshold multiplied by the number of data samples in the plurality of data samples,
perform a fast Fourier transform on the plurality of data samples,
determine a quantity of data samples of the plurality of data samples which are above a spectral threshold,
compare the quantity of data samples of the plurality of data samples which are above the spectral threshold with a sparsity threshold, and
wake up the electronic device when the sum exceeds the RMS threshold multiplied by the number of data samples in the plurality of data samples and the quantity of data samples of the plurality of data samples which are above the spectral threshold is below the sparsity threshold.

2. The electronic device of claim 1, further comprising a signal processor configured to receive signals from the microphone and output the plurality of data samples to the SDC.

3. The electronic device of claim 1, wherein the power source provides ultra-low power to the microphone and the SDC.

4. The electronic device of claim 1, wherein the power source provides full power to the electronic device after being woken up.

5. The electronic device of claim 1, wherein the spectral threshold is 95 dB.

6. The electronic device of claim 1, wherein the sparsity threshold is greater than 50%.

7. The electronic device of claim 1, wherein the SDC includes a FIFO (first in, first out) memory array for storing the plurality of data samples.

8. A speech detection circuit (SDC) comprising:
a first-in, first-out (FIFO) memory array configured to receive and store a plurality of data samples;
a multiplier configured to receive a data sample and square the data sample;
a summer configured to sum a plurality of squared data samples;
a fast Fourier transformer configured to perform a FFT on the plurality of data samples stored in the FIFO;
a counter configured to count a quantity of the plurality of data samples that exceed a spectral threshold;
an RMS comparator configured to compare the summed plurality of squared data samples to an RMS threshold; and
a sparsity comparator configured to compare the quantity of the plurality of data samples that exceed the spectral threshold to a sparsity threshold; and
wherein the SDC outputs a wakeup signal when the summed plurality of squared data samples exceeds the RMS threshold and the quantity of the plurality of data samples that exceed the spectral threshold is less than the sparsity threshold.

9. The SDC of claim 8, further comprising a second FIFO.

10. The SDC of claim 9, wherein the second FIFO stores the plurality of squared data samples.

11. The SDC of claim 10, wherein the summer receives the plurality of squared data samples from the second FIFO.

12. The SDC of claim 8, further comprising a plurality of squarers.

13. The SDC of claim 12, wherein the plurality of squarers each receive one of the plurality of data samples from the FIFO.

14. The SDC of claim 13, wherein the summer receives the plurality of squared data samples from the plurality of squarers.

15. A method of waking up an electronic device, the method comprising:
receiving a plurality of data samples;
squaring the plurality of data samples;
summing the plurality of squared data samples;
comparing the sum with an RMS threshold multiplied by the number of data samples in the plurality of data samples;
performing a fast Fourier transform on the plurality of data samples;
determining a quantity of data samples of the plurality of data samples which are above a spectral threshold;
comparing the quantity of data samples of the plurality of data samples which are above the spectral threshold with a sparsity threshold; and
waking up the electronic device when the sum exceeds the RMS threshold multiplied by the number of data samples in the plurality of data samples and the quantity of data samples of the plurality of data samples which are above the spectral threshold is below the sparsity threshold.

15. (canceled)

16. (canceled)

17. The method of claim 15, wherein the quantity of data samples in the plurality of data samples is n.

18. The method of claim 17, wherein when a new data sample, n+1, is received, the oldest data sample is deleted leaving n data samples in the plurality of data samples.
